(19) United States
(12) Patent Application Publication
(10) Pub. No.: US 2014/0169013 A1
(43) Pub. Date: Jun. 19, 2014

(54) WIRELESS TOW LIGHT SYSTEM

(71) Applicant: TIGER ACCESSORY GROUP, LLC, Long Grove, IL (US)

(72) Inventor: Patrick Naumann, Gurnee, IL (US)

(73) Assignee: TIGER ACCESSORY GROUP, LLC, Long Grove, IL (US)

(21) Appl. No.: 14/011,187

(22) Filed: Aug. 27, 2013

Related U.S. Application Data
(60) Provisional application No. 61/693,484, filed on Aug. 27, 2012.

(51) Int. Cl. B60Q 1/00; B62D 63/08

(52) U.S. Cl. CPC B60Q 1/0094; B62D 63/08; B60Q 1/0076
USPC 362/485

(57) ABSTRACT

A tow light system is provided, including a transmitter unit configured for transmitting an encoded signal, and a receiver unit separate from the transmitter unit and configured for receiving the encoded signal from the transmitter unit. The receiver unit includes a housing, an actuator switch located on the housing, so as to prevent inadvertent access to the actuator switch, and a light unit attached to the housing.

### RELATED APPLICATION

This application claims 35 U.S.C. §119 priority from U.S. Provisional Application No. 61/693,484 filed Aug. 27, 2012.

### BACKGROUND

The present invention generally relates to wireless taillight systems for vehicles, whereby a towed vehicle is wirelessly connected to a towing vehicle such that running, turning or stopping signals from the towing vehicle are transmitted to the towed vehicle. More specifically, the present invention relates to improvements in the construction of towed vehicle receiver and indicator units. Conventional towing light assemblies are designed to address the problem occurring when a trailer, implement or other vehicle (hereinafter “towed vehicle”) is being towed by a tow vehicle, the running, stop and/or turn lights of the tow vehicle are obstructed by the towed vehicle or are otherwise obscured. Many jurisdictions require that the towed vehicle be equipped with supplemental indicator lights for signaling the intentions of the tow vehicle to other traffic. Accordingly, many towed vehicles are equipped with wired-in taillight systems including a connector, such as a jack configured for interfacing with the electrical system of the tow vehicle such that the towed vehicle's lighting system is synchronized with that of the tow vehicle.

Problems of such wired-in systems include that the connectors often become corroded or broken after prolonged use. Another problem is a general failure of the lighting systems in the towed vehicle. U.S. Pat. No. 4,859,982 discloses a wireless taillight system including a transmitting module for placement in the tow vehicle, and a taillight module for placement in the towed vehicle. Radio signals transmitted by the transmitting module correspond to particular light generation patterns of the tow vehicle. The taillight module includes a receiver for receiving such signals and illuminating auxiliary lights on the towed vehicle to correspond to the pattern generated by the tow vehicle. Each of the stop, tail and turn functions of the tow vehicle is assigned a separate frequency in the system, and the receiver is programmed to illuminate the lights on the towed vehicle based on these frequencies. One problem of such systems is that the circuitry is relatively cumbersome and expensive to manufacture.

U.S. Pat. No. 6,100,801 discloses a radio controlled light bar including a tow vehicle unit which is adapted to be electrically connected to the lighting system of the vehicle, and a trailer unit attached to the towed vehicle. The tow vehicle unit includes an analog to RF frequency converter, an RF oscillator, a modulator and a four-channel 900 MHz radio transmitter. The trailer unit includes a radio receiver, a decoder, an amplifier and a managing circuit. In operation, a light signal from the vehicle is converted from analog to RF by the frequency converter. The modulator impresses the light signal onto a carrier frequency as provided by the RF oscillator, and the radio transmitter transmits the signal through one of the four channels or frequencies. Each of the channels of the transmitter is dedicated to one or more of the signals for indicating breaking, tail light and left and right turning of the vehicle.

In the trailer unit, the radio receiver receives the signal transmitted from the tow vehicle unit. The decoder then demodulates the received signal from the RF oscillating frequency and decodes the signal into the light signal received from the vehicle, i.e., breaking, tail light or turning The signal managing circuit then outputs the light signal to the different light elements depending on the type of signal received.

### SUMMARY

An improved wireless taillight assembly incorporates the same technology commonly used in the automotive market for remote keyless entry, alarm systems, gate/garage opening, immobilizers and tire-pressure monitoring systems. More specifically, the present system includes a transmitter unit and a receiver unit. The transmitter unit includes an encoder which connects to the tow vehicle lighting system. Light signals from the vehicle's lighting system are encoded, i.e., encrypted, by the encoder and output to an 8-bit microcontroller.

The microcontroller is programmed with logic to output the received signal to a light display that indicates the signal state at the transmitter unit. The encoder also sends the same encoded signal to a 434 MHz single-channel transmitter, which transmits the encoded signal to the receiver unit. At the receiver unit, a single-channel receiver receives the encoded signal from the transmitter unit, and sends the encoded signal to a microcontroller to decode the signal. The decoded signal is then output by the microcontroller to control the signal functions of the light elements.

More specifically, a tow light system is provided, including a transmitter unit configured for transmitting an encoded signal, and a receiver unit separate from the transmitter unit and configured for receiving the encoded signal from the transmitter unit. The receiver unit includes a housing, an actuator switch located on the housing, so as to prevent inadvertent access to the actuator switch, and a light unit attached to the housing.

In another embodiment, a tow light system is provided, including a transmitter unit configured for transmitting an encoded signal, and a receiver unit separate from the transmitter unit and configured for receiving the encoded signal from the transmitter unit. The receiver unit includes a housing, an actuator switch located on the housing, so as to prevent inadvertent access to the actuator switch, and a light unit attached to the housing. A low battery indicator is attached to the light unit.

In yet another embodiment, a tow light system is provided, including a transmitter unit configured for transmitting an encoded signal, and a receiver unit separate from the transmitter unit and configured for receiving the encoded signal from the transmitter unit. The receiver unit includes a housing, an actuator switch located on the housing, so as to prevent inadvertent access to the actuator switch, and a light unit attached to the housing. A low battery indicator is attached to the light unit. The housing also encloses an interior chamber constructed and arranged for retaining a plurality of batteries in a parallel, generally planar orientation.

### BRIEF DESCRIPTION OF THE DRAWINGS

FIG. 1 is a top perspective view of a receiver unit suitable for use with the present tow light system:

FIG. 2 is a front view of the receiver unit of FIG. 1;

FIG. 3 is an inverted, exploded perspective view of the receiver unit of FIG. 1;

FIG. 4 is a side elevation of the receiver unit of FIG. 1;

FIG. 5 is a rear elevation of the receiver unit of FIG. 1;

FIG. 6 is a bottom plan view of the receiver unit of FIG. 1;

FIG. 7 is a schematic illustrating the transmitter portion of the present tow light system; and

FIG. 8 is a schematic illustrating the receiver portion of the present tow light system.

### DETAILED DESCRIPTION

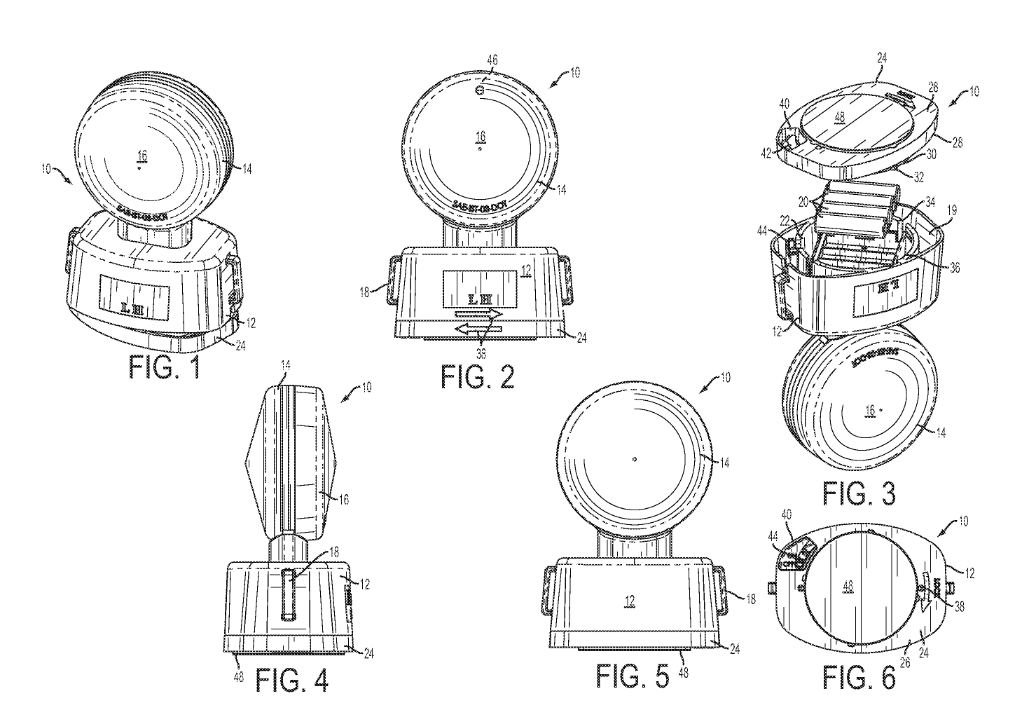

Referring to FIGS. 1-6, a receiver unit is generally designated 10 and includes a base housing 12 to which is attached a light unit 14. As is known in the art, the light unit 14 includes a lens 16 which is tinted according to industry standard, usually amber or red. It is contemplated that the color of the lens 16 may vary to suit the application. Included on the base housing 12 is at least one and preferably two eyelets 18 for accommodating retaining straps (not shown) which secure the unit 10 to the towed vehicle (not shown).

Referring now to FIG. 3, an interior chamber 19 is defined by the base housing 12 and is constructed and arranged for retaining at least one and preferably a plurality of batteries 20, such as AA, AAA or other conventional sizes, depending on the application. Both rechargeable and non-rechargeable batteries 20 are contemplated for use with the present receiver unit 10. In the preferred embodiment, the batteries 20 are housed within a compartment 22 located within the chamber 19. It is preferred that the batteries 20 are disposed in parallel orientation to each other and in a generally planar arrangement.

A base cover 24 includes a base panel 26 and an interior surface 28 having an inwardly projecting collar 30 with radially projecting lugs 32 for engaging corresponding slots 34 in walls 36 of the compartment 22 in a bayonet-style, push-and-twist movement.

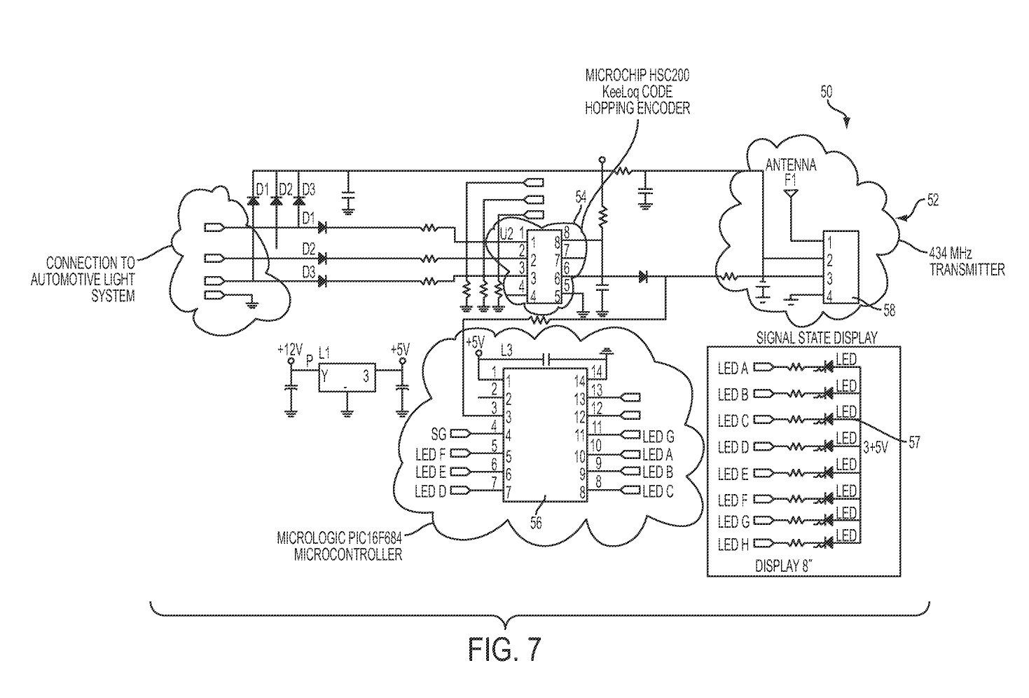

For assisting the user, at least one indicator 38 (FIG. 6) is provided on at least one of the base housing 12 and the base cover 24 for indicating the direction of opening or closing the cover relative to the housing. Another feature of the base cover 24 is a recess or cavity 40 with an opening 42 through which a user can access an actuator switch 44 located in the base housing 12 and which is electrically connected to the batteries 20. In the preferred embodiment, the switch 44 is the slide or toggle type; however other conventional switch types are contemplated. An important feature of the present receiver unit 10 is that the recess 40 provides access to the switch 44, which is recessed relative to the base panel 26 and thus prevents unwanted or inadvertent access to the switch.

Another feature of the present receiver unit 10 is a low battery indicator 46 (FIG. 2) preferably located on, or visible through, the lens 16 or other location easily viewed by the user so that batteries 20 may be exchanged at an appropriate time prior to failure of the system while traveling. While other embodiments are contemplated, the indicator 46 is preferably illuminated, and is optionally an LED or a conventional bulb.

For retaining the receiver unit 10 on the towed vehicle, the base cover 24 is preferably provided with at least one magnet 48. As is known in the art, the magnet 48 is secured to the cover 24 using chemical adhesive, by being insert molded, or using other fastening technologies.

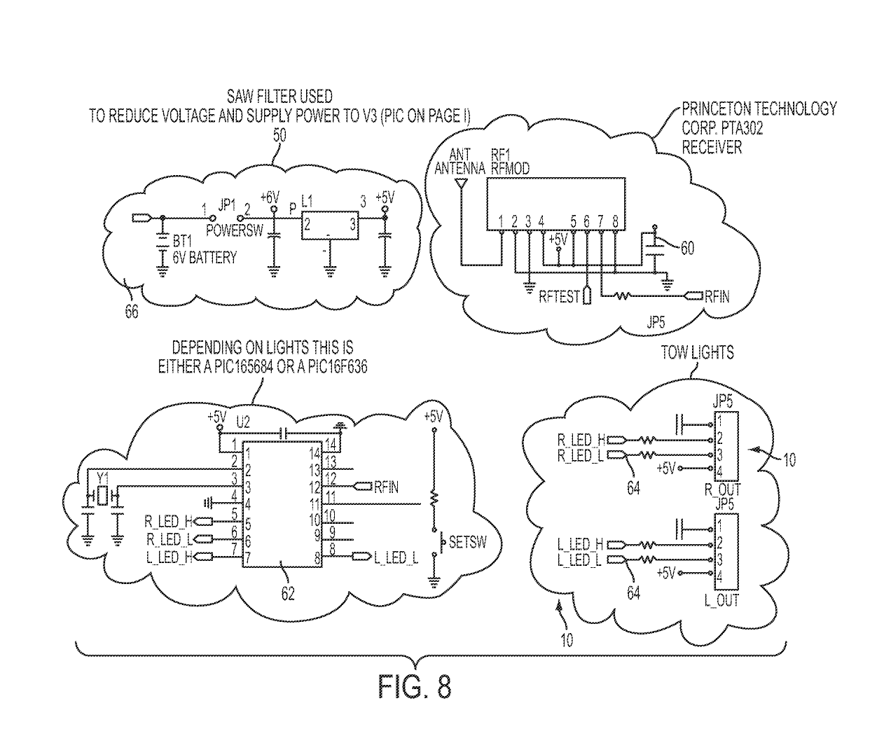

Referring now to FIGS. 7 and 8, the receiver unit 10 is incorporated into a tow light system, generally designated 50, that incorporates the same technology commonly used in the automotive market for remote keyless entry, alarm systems, gate/garage opening, immobilizers and tire-pressure monitoring systems. More specifically, the present tow light system 50 includes a transmitter unit 52 (FIG. 7) and the receiver unit 10 (FIG. 8). Included on the transmitter unit 52, which is mounted on and electrically connected to the tow vehicle, is an encoder 54 configured for being electrically connected to the tow vehicle lighting system (not shown). While other encoders 54 are contemplated, the present unit is an HSC 200 Keeloq code hopping encoder. Light signals from the tow vehicle lighting system are encoded, i.e., encrypted, by the encoder 54 and output to an 8-bit microcontroller 56 such as model no. PIC16F684; however equivalent units are contemplated. The microcontroller 56 is programmed with logic to output the received signal to a light display 57 that indicates the signal state at the transmitter unit 52. The encoder 54 also sends the same encoded signal to a 434 MHz single-channel transmitter 58, which transmits the encoded signal to the receiver unit 10 (FIG. 8).

At the receiver unit 10, a single-channel receiver 60, such as PT4302 or the like, receives the encoded signal from the transmitter unit 52, and sends the encoded signal to a microcontroller 62, models PIC16F684 or PIC16F636 or the like, for decoding the signal. The decoded signal is then output by the microcontroller 62 for controlling the respective, tail, turn and stop signal functions of light elements 64, such as LEDs or bulbs, located in the lens 16 and powered by the batteries 20. In the preferred embodiment, a filter 66, such as a saw filter, is provided to the system 50 for reducing voltage and supplying power to the controller 56.

While a particular embodiment of the present tow light system has been shown and described, it will be appreciated by those skilled in the art that changes and modifications may be made thereto without departing from the invention in its broader aspects and as set forth in the following claims.

1. A tow light system comprising:
a transmitter unit configured for transmitting an encoded signal;
a receiver unit separate from said transmitter unit and configured for receiving the encoded signal from said transmitter unit;
said receiver unit having a housing and an actuator switch located on said housing, so as to prevent inadvertent access to said actuator switch; and
a light unit attached to said housing.

2. The tow light system of claim 1, wherein said housing defines a recess dimensioned for accommodating said actuator switch.

3. The tow light system of claim 1, wherein said housing further includes a removable base cover with a magnet configured for securing said receiver unit to a towed vehicle.

4. The tow light system of claim 3, wherein said removable base cover includes an inwardly projecting collar projecting towards an interior chamber of said housing and having radially outwardly projecting lugs configured for engaging corresponding slots in inner walls of said housing.

5. The tow light system of claim 1, wherein said housing further includes a direction indicator for indicating the direction of opening or closing said removable base cover relative to said housing.

6. The tow light system of claim 1, wherein said housing further includes at least an eyelet for accommodating retaining straps that secure said receiver unit to a towed vehicle.

7. A tow light system comprising:
a transmitter unit configured for transmitting an encoded signal;
a receiver unit separate from said transmitter unit and configured for receiving the encoded signal from said transmitter unit;
said receiver unit having a housing and an actuator switch located on said housing, so as to prevent inadvertent access to said actuator switch;
a light unit attached to said housing; and
a low battery indicator attached to said light unit.

8. The tow light system of claim 7, wherein said low battery indicator is visible.

9. A tow light system comprising:
a transmitter unit configured for transmitting an encoded signal;
a receiver unit separate from said transmitter unit and configured for receiving the encoded signal from said transmitter unit;
said receiver unit having a housing and an actuator switch located on said housing, so as to prevent inadvertent access to said actuator switch;
a light unit attached to said housing;
a low battery indicator attached to said light unit; and
said housing enclosing an interior chamber constructed and arranged for retaining a plurality of batteries in a parallel, generally planar orientation.

10. The tow light system of claim 9, wherein said interior chamber further includes a twist off, lockable cover so that batteries are replaceable without the use of tools.
